(19) United States
(12) Patent Application Publication
(10) Pub. No.: US 2016/0232544 A1
(43) Pub. Date: Aug. 11, 2016

(54) Social Network that Groups Users into Political Constituencies

(71) Applicant: Arthur Andrew Scotson, Spanish Fork, UT (US)

(72) Inventor: Arthur Andrew Scotson, Spanish Fork, UT (US)

(21) Appl. No.: 15/017,149

(22) Filed: Feb. 5, 2016

Related U.S. Application Data
(60) Provisional application No. 62/112,602, filed on Feb. 5, 2015.

(51) Int. Cl. G06Q 30/02; G06Q 50/00; G06Q 50/26

(52) U.S. Cl. CPC G06Q 30/0204; G06Q 50/26; G06Q 50/01

(57) ABSTRACT

A social network is provided that groups users into political constituencies. By grouping users into their political constituencies, the social network can aggregate users' views on various political issues based on the groupings. An aggregate view of a particular issue can therefore provide a general representation of how the particular issue is viewed by a constituency. This grouping of users also allows the views of a constituency's representatives and/or candidates to be displayed in conjunction with the constituency's aggregate view. These aggregate views can also be made available as part of a business model to facilitate the targeted marketing or promotion of political agendas to the users. A candidates page can also be provided where users can view a candidate's views on various issues.

### CROSS-REFERENCE TO RELATED APPLICATIONS

This application claims the benefit of U.S. Provisional Patent Application No. 62/112,602 which was filed on Feb. 5, 2015.

### BRIEF SUMMARY

The present invention extends to methods, systems, and computer program products for providing a social network that groups users into political constituencies. By grouping users into their political constituencies, the present invention can aggregate users' views on various political issues based on the groupings. An aggregate view of a particular issue can therefore provide a general representation of how the particular issue is viewed by a constituency. This grouping of users also allows the views of a constituency's representatives and/or candidates to be displayed in conjunction with the constituency's aggregate view. These aggregate views can also be made available as part of a business model to facilitate the targeted marketing or promotion of political agendas to the users. The present invention can also provide a candidates page where users can view a candidate's views on various issues.

In one embodiment, the present invention is implemented as a method for providing an aggregate view on a political issue. Input is received from each of a plurality of users via a plurality of computing devices. The input identifies each user's view on a political issue. For each view, one or more constituencies to which the user, who provided the view, belongs are identified and an indication of the view is stored in association with the one or more constituencies. An aggregate view on the political issue is generated for a first constituency based on each stored indication that is associated with the first constituency. An interface is generated for displaying the aggregate view in conjunction with an identifier of the political issue and an identifier of the first constituency.

In another embodiment, the present invention is implemented as a method for displaying views of a candidate on a plurality of political issues. Input is received from each of a plurality of candidates via a plurality of computing devices. The input identifies each candidate's views on a plurality of political issues. The views of each candidate are stored along with an indication of a constituency to which each candidate pertains. Information is received from a first user that identifies one or more constituencies to which the user belongs. It is then determined from the information that the first user belongs to a first constituency. The stored views of the candidates are accessed to identify a view on a first political issue of one or more candidates that pertain to the first constituency. An interface is generated for displaying the view on the first political issue of each of the one or more candidates that pertain to the first constituency. The interface is sent to a computing device for display to the first user.

In another embodiment, the present invention is implemented as a method for providing an aggregate view on a political issue. Information is stored for a first constituency. The information defines a view on a political issue of a plurality of users within the first constituency. Input is received from a first user that is within the first constituency. The input selects the political issue. The stored information is accessed to generate an aggregate view on the political issue within the first constituency. The aggregate view is then displayed to the first user.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIGS. 2A and 2B each illustrate an example user interface that can include an aggregate view on a political issue;

FIG. 3 illustrates an example data structure that can be used to store issue data from which an aggregate view can be generated;

FIG. 4 illustrates a flow diagram that represents how issue data pertaining to one or more of a user's constituencies can be obtained and displayed to the user;

FIG. 5 illustrates a flow diagram that represents how a server system can receive a user's view on a particular issue;

FIG. 6 illustrates an example user interface that can display the views of a candidate or representative of a constituency on a number of political issues;

FIG. 7 illustrates a flowchart of an example method for providing an aggregate view on a political issue;

FIG. 8 illustrates a flowchart of an example method for displaying views of a candidate on a plurality of political issues;

FIG. 9 illustrates a flowchart of an example method for providing an aggregate view on a political issue; and

FIG. 10 illustrates an example user interface that can be displayed during a live political event.

### DETAILED DESCRIPTION

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

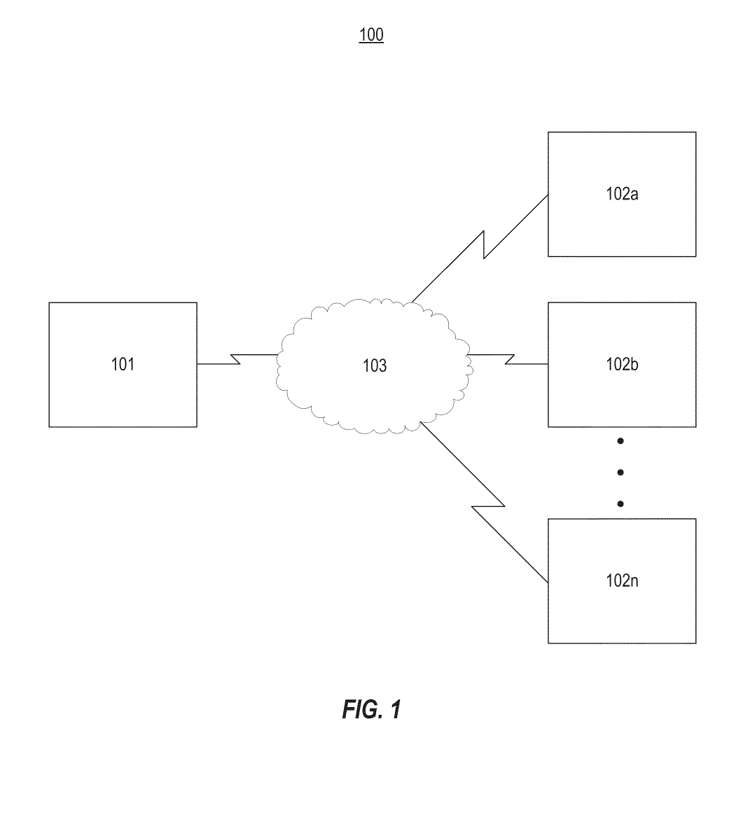

FIG. 1 illustrates an example computer environment 100 in which the present invention can be implemented. Computer environment 100 includes a server system 101 and a number of client computing devices 102a-102n which are interconnected via a network 103. Client computing devices 102a-102n can represent any type of computing device that is capable of communicating with server system 101. For example, client computing devices 102a-102n can include personal computers and mobile phones. Network 103 can typically be the internet; however, any network connection can be employed to enable communication between server system 101 and client computing devices 102a-102n including local network connections.

As will be described below, the present invention provides a number of interfaces and functionality for allowing users to view information about representatives and candidates within the users' constituencies. To enable the collection and presentation of such information, a website or other user interface can be customized according to the particular type of user including regular users, representative (or elected/appointed official) users, candidate users, organization users, influencer users, etc. For example, as is described below, information can be collected from representative and candidate users so that the stated views of such users can be displayed to regular users within their constituencies.

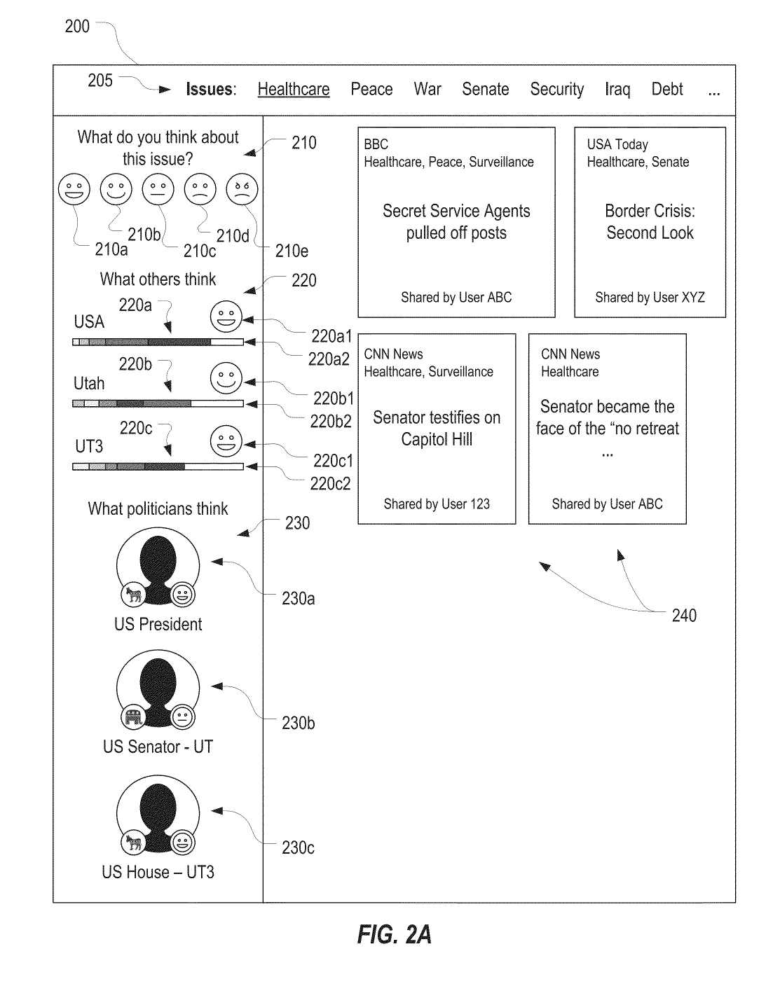

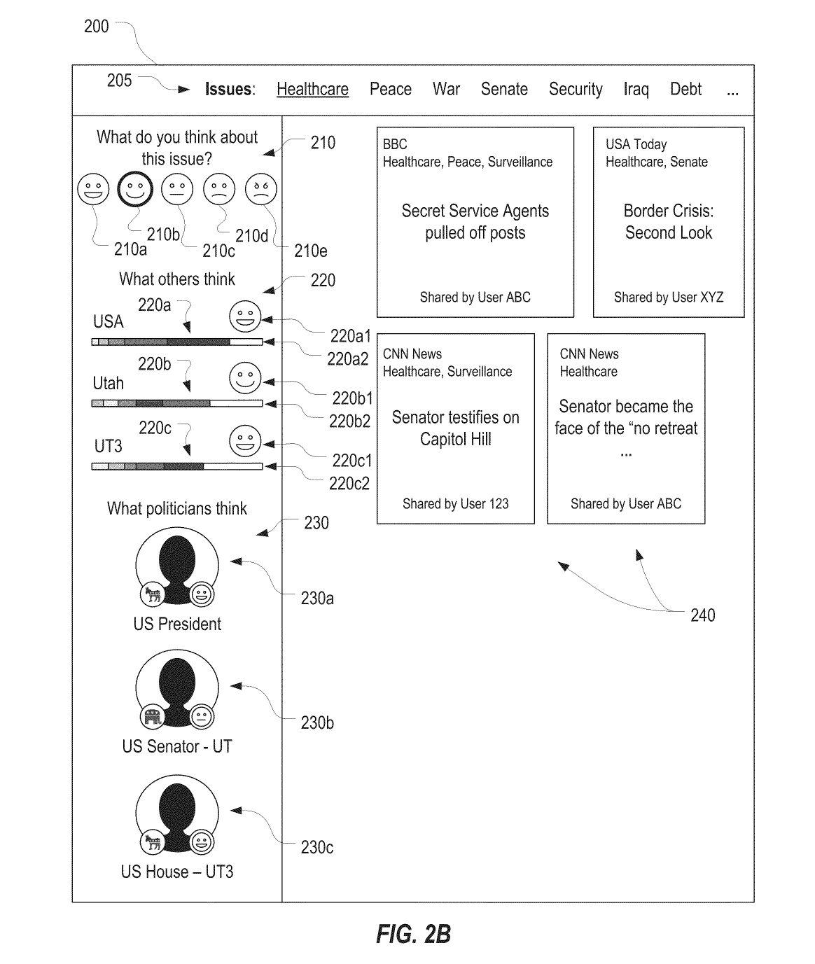

FIG. 2A illustrates an example user interface 200 that can be displayed as part of a social network that groups users into political constituencies. User interface 200 can be displayed on any of client computing devices 102a-102n using content supplied by server system 101. For example, user interface 200 can be a webpage or a user interface of a mobile application (generally referred to as a “website”). Because user interface 200 groups users into their constituencies, content relevant to a user's constituencies can be provided to assist the user to become better informed regarding representatives (e.g., elected or appointed officials) within those constituencies as well as to become better informed regarding the views of other users within the same constituencies.

Accordingly, the content that is displayed within user interface 200 can be customized based on a constituency or constituencies to which the user belongs. For example, if the user is located within the United States, the user may first be prompted to input a zip code or other location identifier. Based on the zip code, it can be determined to which constituencies the user belongs such as the user's district constituency (for the U.S. House of Representatives), the user's state constituency (for the U.S. Senate), and (as a default) the user's national constituency (for the U.S. Presidential Office). Although the United States political structure will be used in this specification to describe the invention, the present invention may equally be used in other political structures. A constituency should therefore be construed broadly as any division of voters. Constituencies at other levels of government, including state and local governments, may also be represented.

User interface 200 provides information about various political issues as shown in the list of issues 205 at the top of the user interface. In the example of FIG. 2A, information about the issue of healthcare is shown as represented by healthcare being underlined. User interface 200 includes various sections each of which provides different types of information regarding a selected issue. A content section 240 provides internet hyperlinks (“links”) to various types of content regarding the selected issue. For example, content section 240 includes links to four online articles. Other types of content to which links may be provided within content section 240 include representative provided content such as online videos, commentary, posts, etc. In short, any type of content to which a link may be provided can be made accessible within content section 240. Links included in content section 240 can be published to a database by input from staff or users of the website. Additionally, if links to original content are provided, the original content can be stored in the database.

Each item within content section 240 can include one or more tags that identify to which issues the content pertains. For example, a link to an article titled Secret Service Agents pulled off posts includes tags for Healthcare, Peace, and Surveillance. These tags can be used to identify whether the content should be displayed within user interface 200 (e.g., by displaying content tagged with healthcare when the healthcare issue is selected in issue section 205). In some embodiments, a tag can be associated with more than one issue so that when any of the associated issues is selected, a link to any content associated with the tag can be displayed.

As stated above, the content that is displayed within content section 240 can be customized based on the user's constituencies. For example, content that is relevant to a selected issue as well as to a representative within the user's constituency can be promoted within content section 240 (e.g., by displaying the content at the top of the content section).

User interface 200 also includes a user view section 210 which allows the user to provide his or her view on a selected issue. As shown, user view section 210 displays five different icons 210a-210e under the heading “What do you think about this issue?” These icons can represent views of “strongly agree,” “agree,” “neutral,” “disagree,” and “strongly disagree” respectively. Of course, other numbers of icons representing greater or fewer views on an issue can be provided. The user can select one of icons 210a-210e to specify his or her view on a selected topic. For example, by selecting icon 210a within user interface 200, the user can specify that he or she strongly agrees with the selected healthcare issue. FIG. 2B represents user interface 200 after the user has selected the view of “agree” for the healthcare issue. As shown, icon 210b has been highlighted to represent the selection.

When a user specifies his or her view on a particular issue, this view can be stored to allow an aggregate view on an issue to be provided. In this specification, an aggregate view should be construed as a view on an issue that is based on the view of each user within a particular constituency. For example, an aggregate view on the healthcare issue for the USA can be based on the view of each user within the USA. Similarly, an aggregate view on the healthcare issue for the third congressional district in Utah can be based on the view of each user within the third congressional district (e.g., each user having a zip code that falls within the third district).

User interface 200 includes an aggregate view section 220 for displaying these aggregate views. As shown in FIG. 2A under the heading of “What others think,” aggregate view section 220 provides indications of the aggregate view on a selected issue within each of the user's constituencies. For example, for the USA constituency, an aggregate view icon 220a1 is provided which indicates that the users within the USA strongly agree with the healthcare issue. Similarly, for the Utah constituency, an aggregate view icon 220b1 is provided which indicates that the users within Utah agree with the healthcare issue.

The value of an aggregate view can be determined in various ways. For example, the value can be chosen based on which view is selected by the most users within the constituency. For example, if more users within Utah specified that they agree with the healthcare issue (e.g., by selecting icon 210b), the aggregate view for Utah on the healthcare issue can be assigned a value of “agree.” On the other hand, in some embodiments, the value of the aggregate view can be based on an averaging of each view. For example, each view can be assigned a number (e.g., 5 for strongly agree, 4 for agree, 3 for neutral, etc.). A sum of all the numbers can then be calculated and used to determine an average value. This average value can then be used to select the value for the aggregate view. For example, if the average value is 4.1, “agree” can be selected for the aggregate view. Accordingly, many different types of calculations can be employed to generate an aggregate view as long as the aggregate view is based on the views of each user within the constituency.

Aggregate view section 220 can also provide an indication of the number of users that have each possible view on the selected topic. For example, indicators 220a-220c include rectangles ordered from smallest to largest that are color coded to identify each possible view. In the example in FIG. 2A, the colors range from darkest for “strongly agree” to lightest for “strongly disagree.” Also, at the far right of each indicator, a white section is provided to indicate the number of users in the constituency that have not yet expressed their view on the selected issue. Accordingly, for the Utah constituency, indicator 220b2 indicates that the view that received the fewest selections is “disagree” followed by “strongly disagree,” “neutral,” “strongly agree,” and then “agree” with the most selections, while about a third of the users in Utah have not yet specified a view.

User interface 200 also includes a representative view section 230 which displays the views of representatives within the user's constituencies. For example, in FIG. 2A, an indication 230a is provided that identifies that the US President strongly agrees with the selected healthcare issue, an indication 230b is provided that identifies that a Utah Senator has a neutral view on the healthcare issue, and an indication 230c is provided that identifies that the representative from Utah's third district strongly agrees with the healthcare issue.

User interface 200 therefore provides a means for quickly identifying how the users within a constituency view a particular issue and for comparing this view with those of the representatives within the constituency. This can facilitate identifying which representatives better represent the views of the constituency.

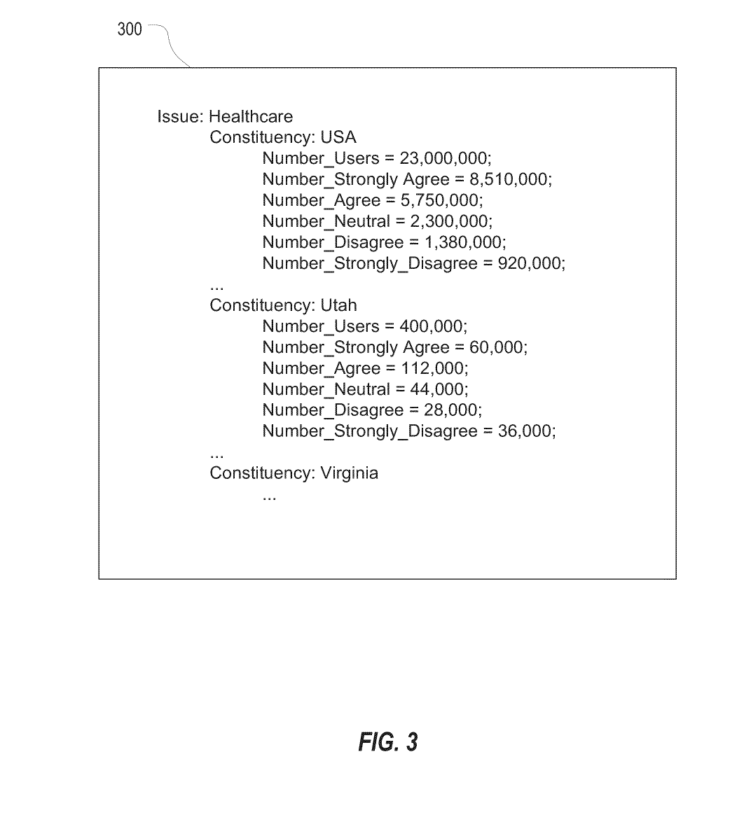

FIG. 3 provides an example of a data structure 300 that can be used to store information regarding users' views on political issues (hereinafter “issue data”) that can be used to create an aggregate view for a particular issue. Data structure 300 is intended merely to represent one generalized structure that can be employed. It is to be understood that many different formats, organizations, and numbers of data structures could also be used to store issue data.

As indicated in its first line, data structure 300 stores issue data for the healthcare issue and includes data for a number of constituencies. For each constituency, data structure 300 defines the total number of users within the constituency as well as, for each available view, the total number of users that have expressed the view. For example, for the USA constituency, the total number of users is defined as 23,000,000. Of these 23,000,000 users, 8,510,000 have expressed that they strongly agree, 5,750,000 have expressed that they agree, 2,300,000 have expressed that they are neutral, 1,380,000 have expressed that they disagree, and 920,000 have expressed that they strongly disagree on the healthcare issue, while 4,140,000 have not expressed their view. From these numbers, the aggregate view on the healthcare issue within the USA constituency can be generated and displayed within user interface 200. Similarly, indicator 220a2 can also be generated from these numbers.

Each time a user within a constituency expresses a view on a particular issue, the pertinent numbers for that issue can be updated. For example, if one of the 4,140,000 of users within the USA constituency (or possibly a new user) expresses that he agrees with the healthcare issue, data structure 300 can be updated to reflect a total number of 5,750,001 users that agree within the USA constituency. Similar updates could be made to the numbers within other constituencies to which the user pertains (e.g. within the Utah constituency if the user resided in Utah). Accordingly, as users express and/or change their views, data structure 300 can be updated to ensure that an appropriate aggregate view can be displayed for each constituency.

Data structure 300 (or another data structure) may also store the view of each user, including politician users, on each issue. For example, server system 101 may update one or more data structures when a user expresses a view on an issue. The storage of this information can facilitate creating representative view section 230 when the views are those of representative users. Additionally, by maintaining the views of each individual (i.e. non-politician) user, server system 101 can provide various tools for targeting users as will be further described below.

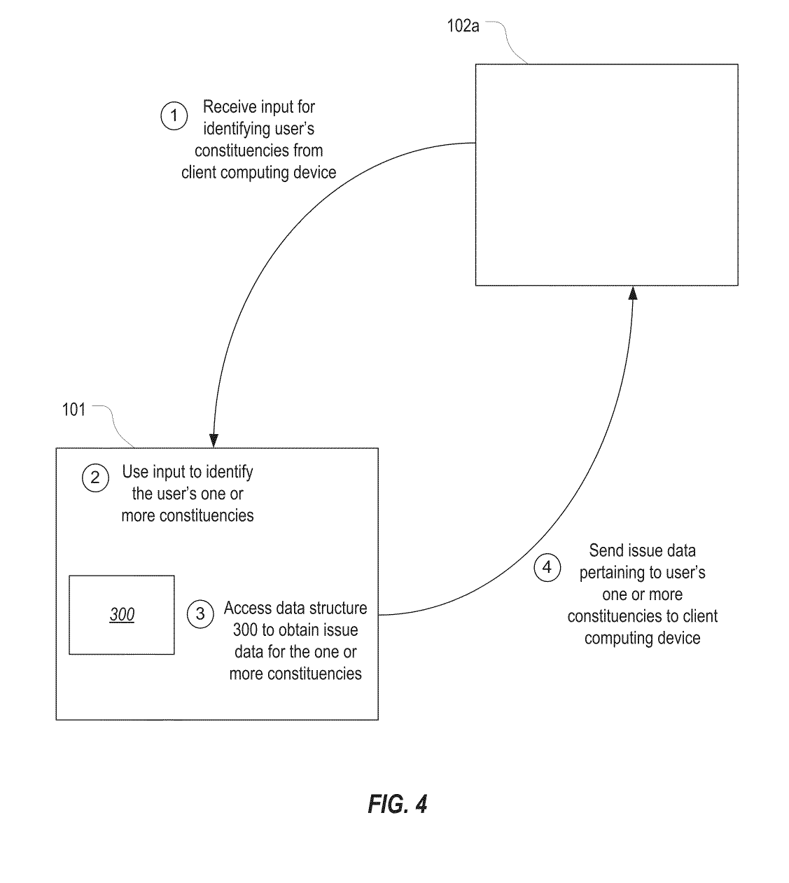

FIG. 4 illustrates a flow diagram that represents how issue data pertaining to one or more of a user's constituencies can be obtained and displayed to the user. As shown, in a first step, server system 101 receives input from client computing device 102a that can be used to identify the user's constituencies. For example, if the user is within the USA, the input may be the user's zip code. In some embodiments, the input may be user input, while in others, the input may be derived automatically from information known about client computing device 102a (e.g., a location of client computing device 102a).

In a second step, server system 101 uses the input received from client computing device 102a to identify one or more constituencies to which the user belongs. For example, if the input is a US zip code, server system 101 can use the zip code to identify the user's district for the US House of Representatives and the user's state for the US Senate. Similarly, server system 101 can use the zip code to identify one or more constituencies at other levels of government such as those at the local (e.g., state) level. In some embodiments, server system 101 can maintain a data structure that maps zip codes or other identifiers to constituencies to facilitate this process.

In a third step, server system 101 can access data structure 300 (or one or more other data structures which store issue data) to obtain the issue data for the user's identified constituencies. For example, if server system 101 determines that the user belongs to the Utah constituency, server system 101 can obtain the issue data defined under Utah within data structure 300 as shown in FIG. 3.

In a fourth step, server system 101 sends the obtained issue data to client computing device 102a for display to the user. For example, if client computing device 102a is accessing server system 101 via a web browser, server system 101 may include the issue data within a webpage similar to user interface 200.

Server system 101 can format the issue data in various ways such as is shown in FIGS. 2A and 2B. For example, server system 101 can provide the issue data in the form of an aggregate view icon (e.g., aggregate view icon 220b1) and/or as an indication of the number of users with each view (e.g., indicator 220b2). The issue data obtained and provided by server system 101 may also include the views of representatives within the user's constituencies such as is shown in representative view section 230.

Although not depicted in FIG. 4, the issue data that is provided to client computing device 102a can be based on various types of user input. For example, if the user provides input that specifies a particular issue, the issue data returned by server system 101 can be issue data for that particular issue. In contrast, if the user provides input that specifies a particular constituency, the issue data can include issue data for multiple issues. For example, an aggregate view icon for the particular constituency can be displayed for a number of issues. Also, as will be further described below, if the user provides input that selects a representative, the issue data returned by server system 101 can include the representative's views on multiple issues. Accordingly, once a user's constituencies are identified, server system 101 can repeatedly send issue data to client computing device 102a based on requests from the user for such data.

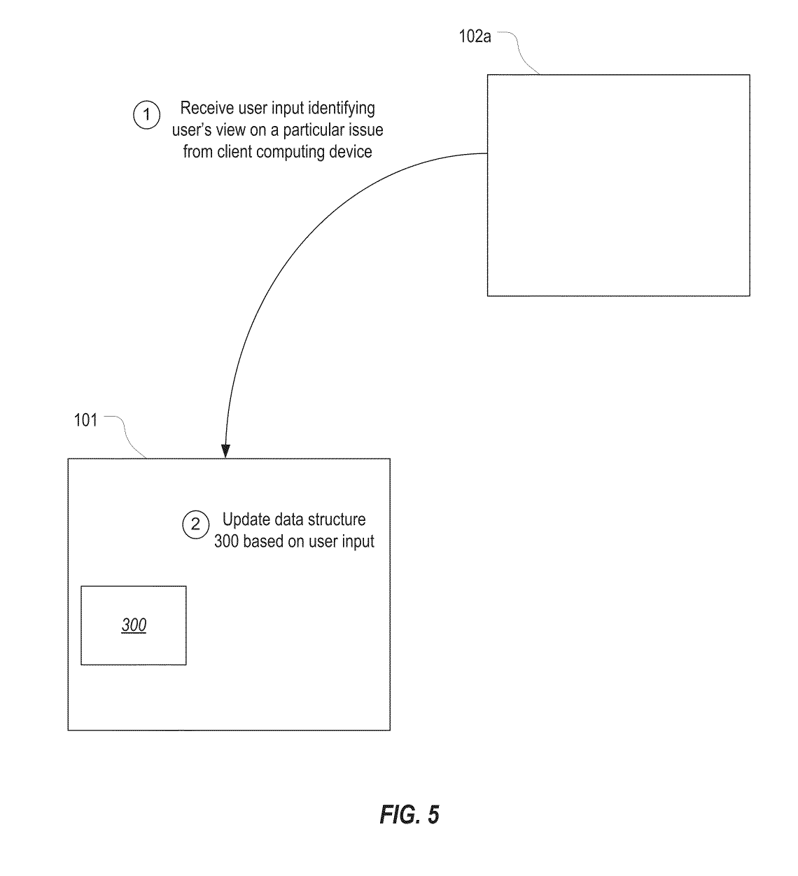

FIG. 5 illustrates a flow diagram that represents how server system 101 can receive a user's view on a particular issue. As shown, in a first step, server system 101 receives user input from client computing device 102a that identifies the user's view on a particular issue. For example, the user input may comprise the user's selection of one of icons 210a-210e within user interface 200. In a second step, server system 101 updates data structure 300 to reflect the user's view. For example, if the user expressed a view of “agree” on the healthcare issue, server system 101 can update the healthcare issue data stored for each constituency to which the user belongs. Accordingly, in FIG. 5, it is assumed that step 1 is performed after or in conjunction with a step for identifying the user's constituencies as described above with reference to FIG. 4.

Assuming that the user belongs to the USA constituency and the Utah constituency and that the user expressed a view of agree on the healthcare issue, server system 101 can update data structure 300 so that the Number_Agree parameters under USA and Utah are incremented by one. Similarly, if server system 101 maintains a data structure for storing the user's individual views, such a data structure can also be updated to indicate that the user agrees on the healthcare issue.

In some embodiments, the present invention can track the veracity of a representative's stated views on the various issues by comparing these views to the representative's voting record, speeches, verbal and written statements, etc. (collectively referred to as “actual view”). Whether the representative's stated view matches his or her actual view on a particular issue can be reflected in user interface 200. For example, if Utah's senator's stated view on the healthcare issue matches his or her actual view, representation 230b could appear as shown in FIGS. 2A and 2B (i.e., without any indicator), whereas if they differed, representation 230b could be modified to include some visual indicator representing the discrepancy (e.g., a colored border around all or a portion of representation 230b). In some embodiments, the degree to which the stated and actual view differed could be represented using the visual indicator.

Also, in such embodiments, links may be provided to content that demonstrates the representative's actual view on the issue. For example, if Utah's senator had a stated view of agree for the healthcare issue, but had voted against a healthcare bill and spoken unfavorably about the bill, links to the senator's voting record and news articles reporting the senator's speech could be provided in user interface 200. In this way, users can verify whether the representatives' stated views match their actual views on the issues.

In embodiments where information about a representative's actual view on an issue is obtained, this actual view can be used in place of a stated view if the representative has not yet provided a stated view. For example, if Utah's senator has not yet provided a view on the healthcare issue, representation 230b could be generated based the senator's voting record and speeches about the healthcare issue. In such cases, the appearance of representation 230b can be customized (e.g., with a color, associated text, etc.) to indicate that representation 230b represents the senator's actual rather than stated view. This can allow user interface 200 to provide a complete record of a representative's views even if the representative has not provided stated views on all issues. As described above, when a representative's actual view rather than stated view is provided within user interface 200, links to the content on which the actual view is based can be provided. Also, once the representative provides a stated view, the stated view can replace the actual view within user interface 200.

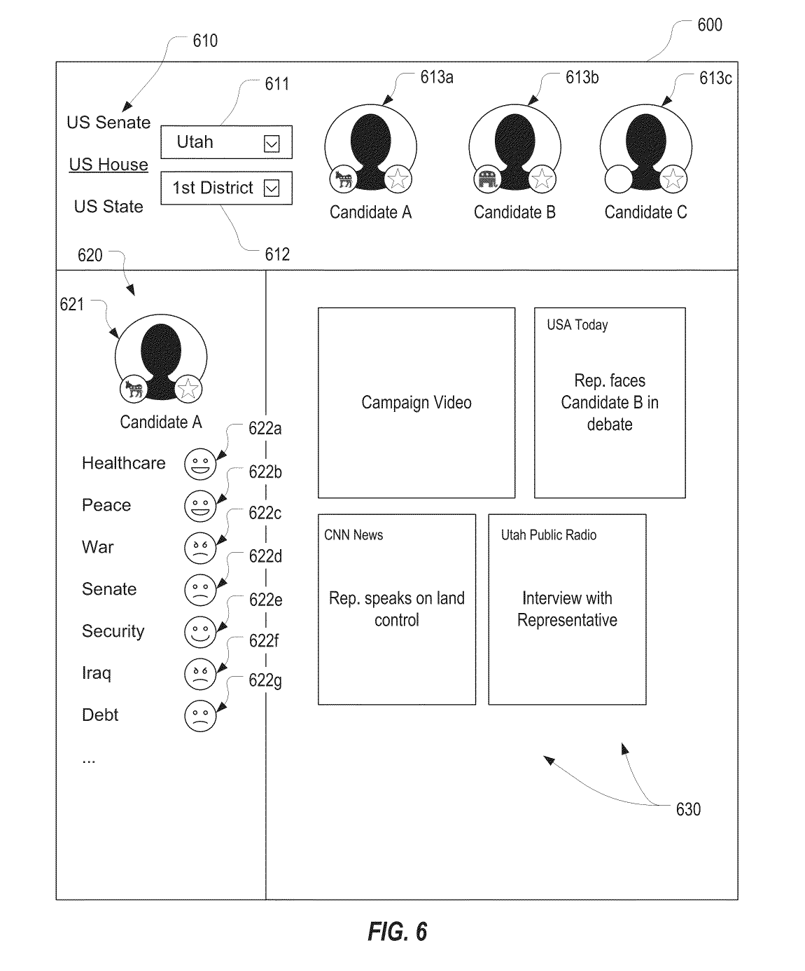

FIG. 6 illustrates a candidate user interface 600 that can be displayed to represent a candidate's views on a number of issues. Candidate user interface 600 can be generated based on information stored by server system in one or more data structures which define a candidate's views on the issues. This information can be obtained by server system 101 in the manner described with reference to FIG. 5 or in another suitable way. Accordingly, candidate user interface 600 is similar to user interface 200 except that candidate user interface 600 provides information about candidates within constituencies whereas user interface 200 provides information about elected or appointed representatives within constituencies.

Candidate user interface 600 includes a constituency section 610 which lists various constituency groups within a user's geographic area. For example, constituency section 610 is shown as including US Senate, US House, and US State. Each constituency group represents possibly a number of constituencies that belong to the group. Based on which constituency group is selected, option boxes 611 and 612 will be populated with the corresponding constituencies. For example, in FIG. 6 the US House constituency group has been selected as indicated by the underline. Option box 611 will therefore include each state within the US to allow the user to select a particular state. Based on which state is selected within option box 611, option box 612 will be populated with each constituency that falls within the selected state that is also a US House constituency. Of course, the number of option boxes that are presented may vary depending on which constituency group is selected. For example, if the US Senate constituency group is selected, a single option box (e.g., option box 611) may be presented since states are not subdivided into constituencies for the US Senate. Also, a USA constituency group (i.e., a US presidential constituency) may not require any option boxes since there is only a single constituency.

In FIG. 6, the user has selected Utah within option box 611 and 1^{st} District within option box 612. As a result, candidates for Utah's first district in the US House of Representatives are displayed. As shown, representations 613a, 613b, and 613c are displayed for three candidates. Any of these representations can be selected to cause user interface 600 to be updated to include the views of the selected candidate on various issues. For example, in FIG. 6, a representation 621 for Candidate A is displayed within a selected candidate area 620 to indicate that the user has selected representation 613a. Selected candidate area 620 lists a number of issues along with icons 622a-622g which define the candidate's views on the issues. In this way, a user can quickly identify a candidate's views on many different issues including candidates in constituencies to which the user does not belong.

Any of icons 622a-622g can represent either the candidate's stated view, when one has been provided, or the candidate's actual view, when one has not been provided, in a similar manner as described above.

Candidate user interface 600 also includes a content section 630 that includes content about the selected candidate. For example, content section 630 is shown as including a campaign video for Candidate A and three articles about Candidate A. Content section 630 therefore allows the user to easily learn more about the selected candidate.

Because server system 101 can maintain information defining the views of users within a constituency, this information can be provided to candidates, elected officials, political parties, political groups, advertising groups, etc. to enable the provision of targeted content to such users. For example, a candidate within a particular constituency may be able to obtain the views (whether as an aggregate view or as individual views) of the users within the constituency on a particular issue. The candidate can then increase his or her efforts to promote a particular view or to influence the views of the users.

Server system 101 can also provide custom demographic reports based on user provided demographic data such as age, gender, ethnicity, party affiliation, ideological affiliation, income level, registered voter status, geographic locality (e.g., city, county, state, a zip code, a set of zip codes), etc. This demographic data can be collected as part of a user registration or other process. For example, server system 101 can allow a candidate to identify how many people support the Affordable Care Act that match the following criteria: African American, male, age 24-36, reside in the state of Utah, registered with the Republican party, identify as liberal, and have an income up to $25,000. Knowing such information can enable a candidate or other user to target messages or advertisements to users matching highly granular criteria.

Similarly, server system 101 can allow targeted content to be distributed to users within particular constituencies having particular views. For example, if a candidate desires to present a message only to users within his or her constituency that have a particular view, server system 101 can use its stored issue data to identify the users matching the specified criteria and route the message only to those users.

In some embodiments, users of the present invention can be awarded with badges, titles, and/or rewards for interacting with the various interfaces described above and other interfaces that are included in a website, mobile application, or the like (hereinafter “website”). For example, these awards may be provided for participating in beta tests of the website, completing a user profile, commenting regularly on the website, using the website regularly, having a higher average session time on the website, posting content on the site, donating to candidates, viewing ads and providing efficacy feedback on those ads via surveys, etc.

In some embodiments, a user can follow or otherwise connect with another user whether the other user is a regular user, a representative user, a candidate user, an organization user, etc. Similarly, a user can join a group of users or join an event. Following another user can cause a custom feed to be provided to the user that includes content generated by the actions of the other user. For example, if the other user comments on content, the comment can be provided in the custom feed. A user can similarly follow an issue. Following an issue will cause the user's custom feed to include any content generated about the followed issue including any comments on such content.

In some embodiments, the present invention can be configured to allow a user to share content, issues, or the website itself on other social networking platforms such as Facebook and Twitter. For example, when a user provides a comment within user interface 200, 600 or other similar interface, the comment can automatically be posted to the user's Facebook account. Similarly, if a user likes an article, follows an issue, follows a user, joins a group, creates or joins a political event, chooses a favorite representative, etc., such actions can be automatically populated to another social networking account.

In some embodiments, the content that is displayed within content section 240 (or similarly, within a custom feed) can be prioritized based on a ranking system. For example, the above discussion of content section 240 provides an example where content is organized based on a selected issue. However, when content is prioritized based on a ranking system, the content may be ordered based on various factors including whether the content is related to an issue or user that the user is following, whether the content was generated by staff of the website, and the popularity of the content among other users. For example, content relating to issues or users that the user is following may appear at the top of content section 240 followed by content generated by staff, and then remaining content sorted based on its popularity. In some embodiments, sponsored content may be excluded from this ranking system such that it always appears at the top of content section 240 and appears prominently in the user's custom news feed. This sponsored content may include an identifier of the user that sponsored the content.

In a particular embodiment, the following steps can be followed to determine the display priority of content within content section 240. In a first step, the user's stated preferences, the user's selection of issues and other users to follow, and the user's activity and/or behavior on the website are determined. In a second step, a priority score is assigned to each piece of content available to be displayed within content section 240. This priority score is based on the user's stated preferences, the issues and users that the user follows, and the user's activity. Content having the highest priority score is displayed at the top of section 240 followed by content having a lower priority score. Content in a user's custom news feed can be prioritized in the same manner.

In some embodiments, the present invention may also provide a user interface for following and participating in a live political event. The user interface can also provide functionality for a user to create and publish events. For example, the present invention can allow a user to create and publish a political debate, protest, town hall meeting, Q&A, or live news production. Other users can then follow and participate in such events including by sharing their views on participants of the event while the event is proceeding. In this specification, a live political event should be construed as encompassing events where the content being viewed is a live stream as well as events where the content being viewed is a recorded stream.

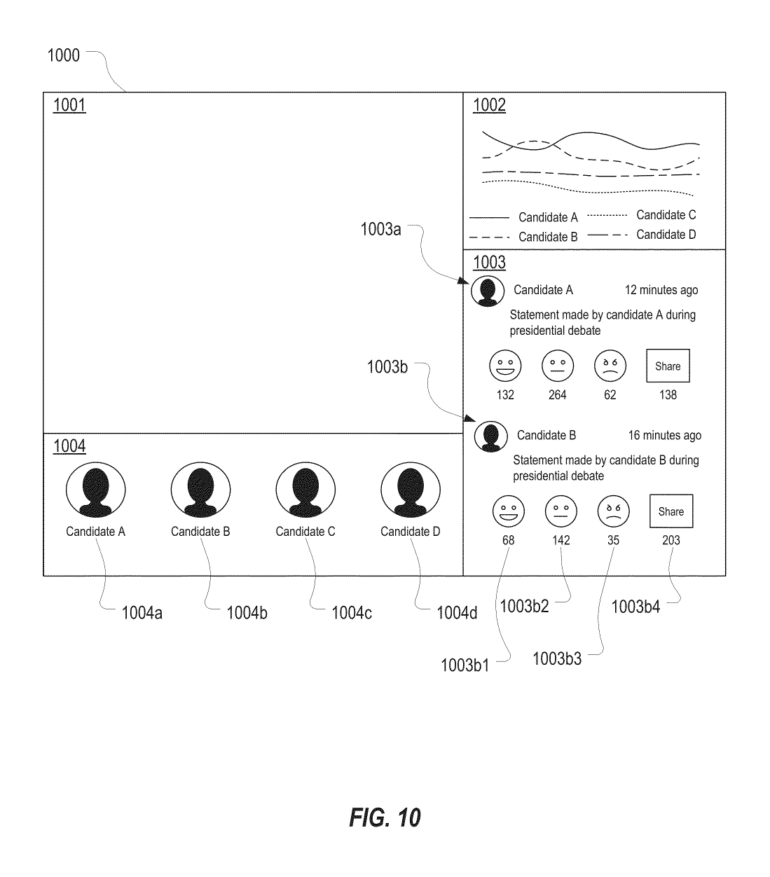

FIG. 10 provides an example of a user interface 1000 that can be presented to a user to allow a user to follow and participate in a live political event. In this example, the event is a presidential debate. User interface 1000 includes a video feed section 1001 in which a video stream of the presidential debate can be displayed. As stated above, the video stream can be a live stream or a recorded stream.

User interface 1000 also includes a participant section 1004 in which representations of the participants in the event are displayed. In this example, representations 1004a-1004d of four presidential candidates are displayed. Each of representations 1004a-1004d can be selectable to allow a user to select a participant that the user supports. These selections can be used to dynamically customize the display of participant section 1004 during the event. For example, the order of representations 1004a-1004d can be customized based on the percentages of users that support each candidate. Alternatively, a visual indicator (not shown) can be displayed in conjunction with representations 1004a-1004d to indicate a number or percentage of users that support each candidate.

User interface 1000 also includes a statements and positions section 1003 which lists a number of statements made or positions taken by the participants during the event. Statements and positions section 1003 can be updated dynamically during the event as the participants make new statements or take new positions. For example, statements and positions section 1003 includes a first entry 1003a comprising a statement made by candidate A and a second entry 1003b comprising a statement made by candidate B during the presidential debate. Each entry 1003a, 1003b can include an indicator of which candidate made the statement or took the position, an indicator of a time when the candidate made the statement or took the position (e.g., 12 minutes ago), a number of selectable options to allow users to identify whether they support, oppose, or are neutral on the statement or position, and an option to share the statement or position with other users. Entries in statements and positions section 1003 can be created by staff of the website or by users that are participating in the event.

For example, second entry 1003b includes a first option 1003b1 which a user can select to indicate that he or she supports the corresponding statement, a second option 1003b2 which a user can select to indicate that he or she neither supports nor opposes the corresponding statement, and a third option 1003b3 which a user can select to indicate that he or she opposes the corresponding statement. Second entry 1003b also includes an option 1003b4 that a user can select to share the corresponding statement with other users (e.g., within the same website or via Facebook, Twitter, or other social networking platform).

Each of options 1003b1-1003b4 includes a count of the number of users that have selected the option during the event. For example, option 1003b1 includes a count of 68 indicating that 68 users have stated that they support the corresponding statement. Option 1003b4 includes a count of 203 indicating that the corresponding statement has been shared by 203 users.

User interface 1000 also includes an aggregate view section 1002 which displays a graph representing a constituency's aggregate view of each candidate. A graph can be used to represent the changes in the aggregate view during the course of the event. The value of each graph can be based on user input to one or both of participant section 1004 and statements and positions section 1003. For example, the graph for candidate B can be based on the number of users that have selected options 1003b1-1003b3 as well as those pertaining to other statements made or positions taken by candidate B during the presidential debate. In FIG. 10, user interface 1000 only includes a single aggregate view section 1002. However, in some embodiments, an aggregate view section 1002 may be provided for each constituency to which the user belongs.

Although not shown in FIG. 10, user interface 1000 can include a comments section where users can input comments regarding the event. Similarly, for some events, user interface 1000 can include a questions section in which a user can input questions to a moderator or participant of the event. For example, during a debate, the user can input a question for the participants of the debate to discuss. In some embodiments, user interface 1000 can include a flash poll section in which the users viewing the event can be asked to answer one or more questions during the event.

User interface 1000 therefore provides a way for a remote user to participate in a political event by both viewing the event and providing views on the participants' comments during the event. Any user can create an event and advertise it within the website. The website may provide a listing of scheduled events to allow the user to identify events in which he or she may desire to participate. The website may also allow the user to register for an event. Once registered, the user can receive information about the event including messages from the creator of the event and notifications or reminders about the event. In some embodiments, events can be recommended to a user based on the user's stated preferences, profile, or behavior on the website. Once an event has commenced, a user can be given an option to join the event which will cause a user interface similar to user interface 1000 to be generated and displayed to the user.

Any input that users provide via user interface 1000 during an event can be stored for later use in generating custom demographic reports. These custom demographic reports can be similar to those described above, but are particular to the event. For example, using information obtained via user interface 1000, a report could be generated that identifies how many female users ages 18-24 indicated that they support a particular position taken by candidate A during the presidential debate.

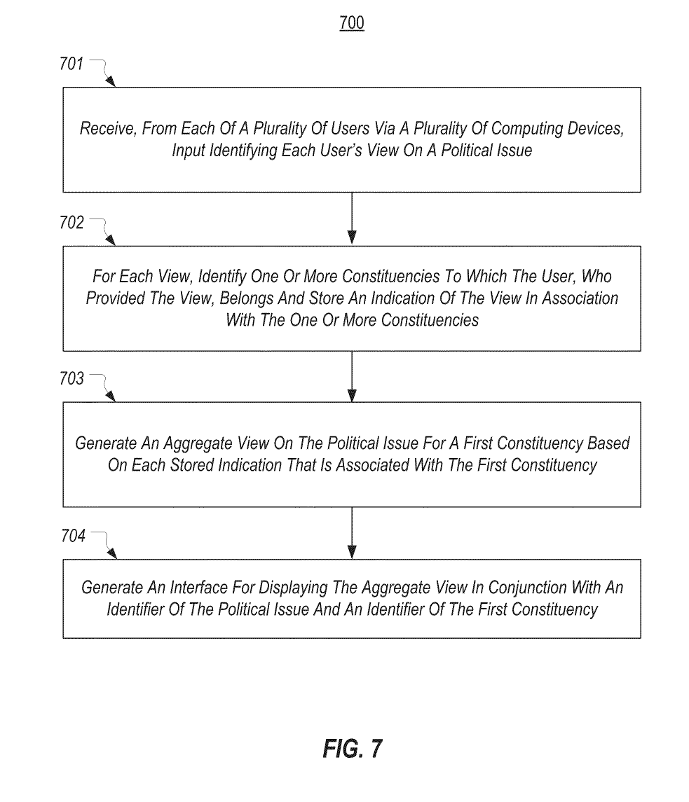

FIG. 7 illustrates a flowchart of an example method 700 for providing an aggregate view on a political issue in accordance with one or more embodiments of the invention. Method 700 will be described with reference to FIGS. 2A-5.

Method 700 includes an act 701 of receiving, from each of a plurality of users via a plurality of computing devices, input identifying each user's view on a political issue. For example, server system 101 can receive input from a plurality of users that selects one of icons 210a-210e to represent the users' views on a particular political issue such as the healthcare issue.

Method 700 includes an act 702 of, for each view, identifying one or more constituencies to which the user, who provided the view, belongs and storing an indication of the view in association with the one or more constituencies. For example, server system 101 can use a zip code for a particular user to determine that the particular user belongs to a USA, Utah, and Utah Third District constituency and store the user's view of “agree” in association with each of these constituencies (i.e., as issue data). A data structure such as data structure 300 can be used to store the user's view in this manner

Method 700 includes an act 703 of generating an aggregate view on the political issue for a first constituency based on each stored indication that is associated with the first constituency. For example, server system 101 can use issue data for the first constituency to generate an aggregate view of the healthcare issue.

Method 700 includes an act 704 of generating an interface for displaying the aggregate view in conjunction with an identifier of the political issue and an identifier of the first constituency. For example, server system 101 can generate user interface 200 to display the aggregate view icon 220b1 in conjunction with an identifier of the healthcare issue and an identifier of the Utah constituency.

In some embodiments, method 700 may also include an act of displaying the view of one or more politicians that pertain to the first constituency, or another constituency to which the user belongs, in conjunction with the aggregate view. For example, server system 101 can include representations 230a-230c which identify the views of various politicians within the user's constituencies.

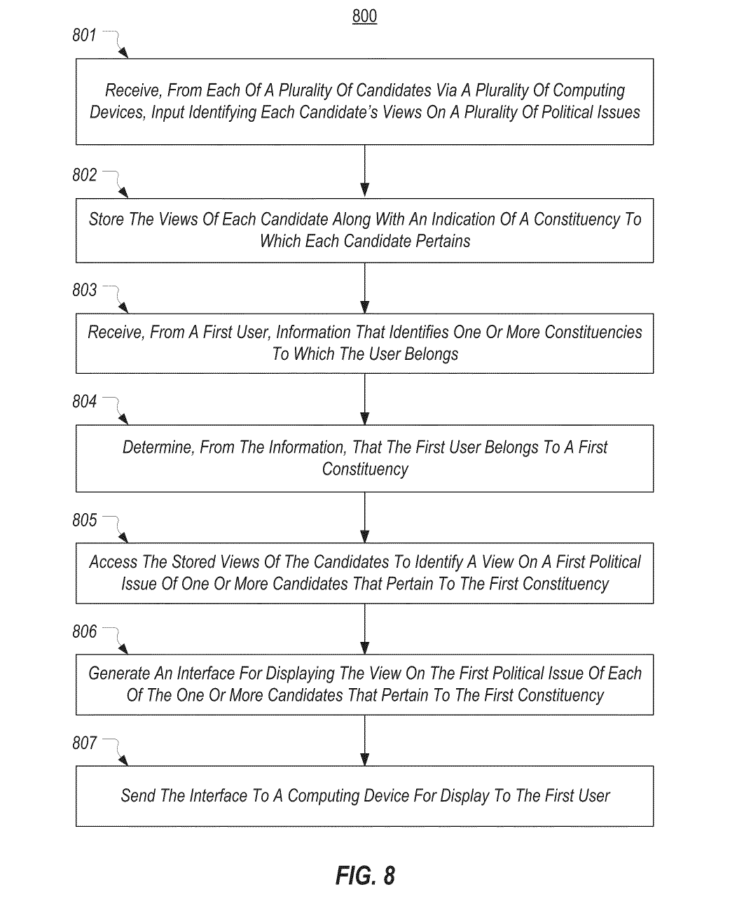

FIG. 8 provides a flowchart of an example method 800 for displaying views of a candidate on a plurality of political issues. Method 800 will be described with reference to FIG. 6.

Method 800 includes an act 801 of receiving, from each of a plurality of candidates via a plurality of computing devices, input identifying each candidate's views on a plurality of political issues. For example, server system 101 can receive input from each candidate for each of the political issues.

Method 800 includes an act 802 of storing the views of each candidate along with an indication of a constituency to which each candidate pertains. For example, server system 101 can maintain one or more data structures that store an indication of which constituency a candidate pertains along with the views of the candidate on the political issues.

Method 800 includes an act 803 of receiving, from a first user, information that identifies one or more constituencies to which the user belongs. For example, server system 101 can receive a zip code of the first user.

Method 800 includes an act 804 of determining, from the information, that the first user belongs to a first constituency. For example, server system 101 may maintain a data structure that maps the zip code of the first user to a number of different constituencies.

Method 800 includes an act 805 of accessing the stored views of the candidates to identify a view on a first political issue of one or more candidates that pertain to the first constituency. For example, server system 101 can access one or more data structures to identify the view of a candidate within the first constituency on the healthcare issue.

Method 800 includes an act 806 of generating an interface for displaying the view on the first political issue of each of the one or more candidates that pertain to the first constituency. For example, server system 101 can generate user interface 600 to display the view of the one or more candidates on the healthcare issue.

Method 800 includes an act of sending the interface to a computing device for display to the first user. For example, server system 101 can send user interface 600 to client computing device 102a.

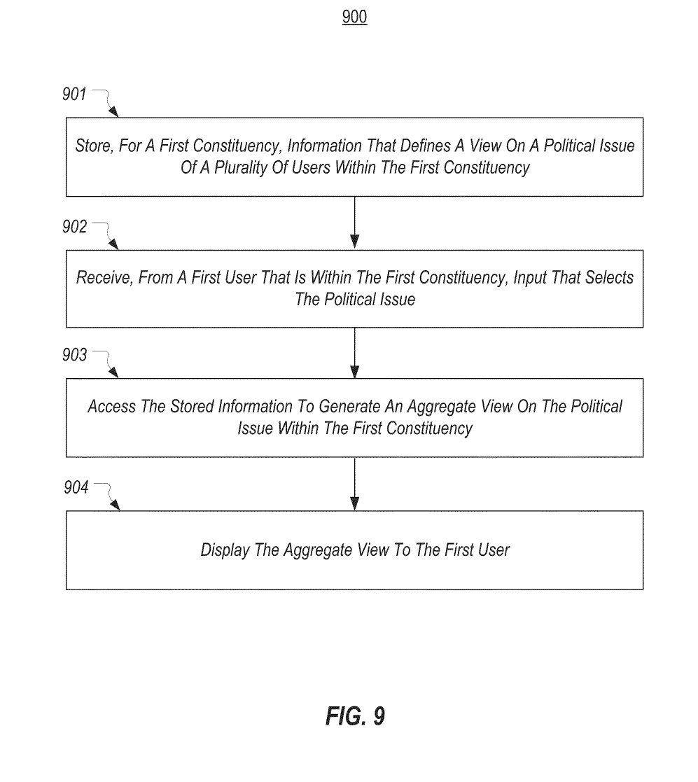

FIG. 9 illustrates a flowchart of an example method 900 for providing an aggregate view on a political issue. Method 900 will be described with reference to FIGS. 2A-5.

Method 900 includes an act 901 of storing, for a first constituency, information that defines a view on a political issue of a plurality of users within the first constituency. For example, server system 101 can maintain a data structure such as data structure 300 which defines the views of users within one or more constituencies on a political issue.

Method 900 includes an act 902 of receiving, from a first user that is within the first constituency, input that selects the political issue. For example, server system 101 can receive input from a user that selects the healthcare issue from within the list of issues 205 displayed in user interface 200.

Method 900 includes an act 903 of accessing the stored information to generate an aggregate view on the political issue within the first constituency. For example, server system 101 can access a data structure such as data structure 300 to generate an aggregate view on the healthcare issue for the first constituency.

Method 900 includes an act 904 of displaying the aggregate view to the first user. For example, server system 101 can send user interface 200, or information for generating user interface 200, to client computing device 102a.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method, implemented by a computing system, for providing an aggregate view on a political issue, the method comprising:
receiving, from each of a plurality of users via a plurality of computing devices, input identifying each user's view on a political issue;
for each view, identifying one or more constituencies to which the user, who provided the view, belongs and storing an indication of the view in association with the one or more constituencies;
generating an aggregate view on the political issue for a first constituency based on each stored indication that is associated with the first constituency; and
generating an interface for displaying the aggregate view in conjunction with an identifier of the political issue and an identifier of the first constituency.

2. The method of claim 1, wherein the input identifying a user's view on a political issue comprises input that selects one of a plurality of icons displayed in conjunction with an identifier of the political issue.

3. The method of claim 1, wherein identifying one or more constituencies to which a user belongs comprises identifying a location of residence of the user.

4. The method of claim 3, wherein identifying a location of residence of the user comprises receiving user input of the location.

5. The method of claim 1, wherein storing an indication of the view in association with the one or more constituencies comprises maintaining a count of a number of users within each of the one or more constituencies that have the view on the political issue.

6. The method of claim 1, wherein the aggregate view identifies which view out of a number of different views on the political issue is shared by the most users within the first constituency.

7. The method of claim 1, wherein the aggregate view identifies an average of different views on the political issue held by users within the first constituency.

8. The method of claim 1, wherein the aggregate view is displayed as an icon.

9. The method of claim 1, wherein the aggregate view represents a number of users within the first constituency that have each of a number of different views on the political issue.

10. The method of claim 1, wherein the interface also displays a view on the political issue of one or more politicians within the first constituency.

11. The method of claim 1, wherein the interface also displays one or more links to content about the political issue.

12. The method of claim 1, further comprising:
sending the interface to a user within the first constituency that has not specified a view on the political issue, wherein the interface includes a plurality of options representing a plurality of potential views on the political issue, the plurality of options being selectable to allow the user to specify a view on the political issue.

13. A method, implemented by a computing system, for displaying views of a candidate on a plurality of political issues, the method comprising:
receiving, from each of a plurality of candidates via a plurality of computing devices, input identifying each candidate's views on a plurality of political issues;
storing the views of each candidate along with an indication of a constituency to which each candidate pertains;
receiving, from a first user, information that identifies one or more constituencies to which the user belongs;
determining, from the information, that the first user belongs to a first constituency;
accessing the stored views of the candidates to identify a view on a first political issue of one or more candidates that pertain to the first constituency;
generating an interface for displaying the view on the first political issue of each of the one or more candidates that pertain to the first constituency; and
sending the interface to a computing device for display to the first user.

14. The method of claim 13, wherein the interface also displays the view on the first political issue of each of one or more candidates that pertain to a second constituency to which the user belongs.

15. The method of claim 14, wherein the first political issue is selected by the user.

16. The method of claim 13, wherein the interface also displays the view on one or more other political issues of at least one of the one or more candidates.

17. The method of claim 16, wherein the interface displays the views of a first candidate that pertains to the first constituency on a plurality of political issues, the first candidate being selected by the user.

18. The method of claim 13, wherein the interface also displays one or more links to content about the political issue.

19. A method, implemented by a computing system, for providing an aggregate view on a political issue, the method comprising:
storing, for a first constituency, information that defines a view on a political issue of a plurality of users within the first constituency;
receiving, from a first user that is within the first constituency, input that selects the political issue;
accessing the stored information to generate an aggregate view on the political issue within the first constituency; and
displaying the aggregate view to the first user.

20. The method of claim 19, further comprising:
identifying a view of one or more candidates within the first constituency on the political issue; and
displaying the view of each of the one or more candidates with the aggregate view.
